(19) United States
(12) Patent Application Publication
(10) Pub. No.: US 2008/0146199 A1
(43) Pub. Date: Jun. 19, 2008

(54) AUTOMATED MAILBOX TRIGGERS AND MESSAGING

(76) Inventors: Samuel Jacob HORODEZKY, San Diego, CA (US); Manuel E. JAIME, Solana Beach, CA (US); Donald John JONES, Cardiff, CA (US)

Correspondence Address: QUALCOMM INCORPORATED, 5775 MOREHOUSE DR., SAN DIEGO, CA, 92121, US

(21) Appl. No.: 11/610,307

(22) Filed: Dec. 13, 2006

(51) Int. Cl. H04M 1/64; H04M 3/42

(52) U.S. Cl. 455/413; 455/415

(57) ABSTRACT

A telecommunications device and/or service are provided that enable a user of a receiving device to associate a caller of an incoming call with a response that is appropriate for the caller. The incoming call includes call data that identifies the particular caller. When received, the recipient's device processes the incoming call and sends the associated appropriate response.

### BACKGROUND OF THE INVENTION

The invention relates generally to the field of telecommunications, and more particularly to responding to incoming calls on telecommunications devices.

People today make widespread use of telecommunications equipment. Nearly every family in this country has, at a minimum, conventional wired telephone service, and very many also have mobile devices that provide wireless telecommunications services. Cellular telephone calls are made so frequently that it is a routine part of many people's day.

Often, people use a voice message service (which may be included in an electronic voicemail mailbox) to answer the phone when they do not wish to be disturbed or otherwise find it inconvenient to answer the phone. When people anticipate that they will be receiving a phone call that they will be unable to answer, they can change their voicemail greeting message from a generic message to a specific message that is targeted for a person at a specific time.

Unfortunately, other callers might receive the message inappropriately. To avoid continuing to send a stale and inappropriate greeting to the callers, the owner of the mailbox would have to change the message to a generic version. Often the change would transpire after the specific time the message was valid for the targeted person. Because of time constancy, the owner may forget to change the message until being notified by someone else who receives the stale message.

An alternative method and mechanism for incoming message announcement has eluded those skilled in the art, until now.

### SUMMARY OF THE INVENTION

The invention is directed to telecommunications devices and services that enable a user to assign beforehand, on a call-receiving device, a response to be sent to a call-originating device. In one aspect, a method is provided for associating call announcements with receiving devices. The method includes storing contact information on a receiving device, where the contact information describes an originating device, and the contact information has a particular contact response that is appropriate for the originating device; and receiving an incoming call having identifying information for identifying the originating device. The method further includes associating the received identifying information with the contact information stored on the receiving device; and initiating an outbound call from the originating device to the receiving device, so that the outbound call comprises the particular contact response.

In another aspect, a method is provided for placing a call to a receiving device from an originating device. The method includes sending call data associated identifying the originating device to the receiving device, selecting and sending a response type to the receiving device, and receiving a response from the receiving device, the response being of the response type.

In yet another aspect, a method is provided for responding to an incoming call on a receiving device. The method includes receiving call data associated with an incoming call, the call data identifying an originating device, and associating locally stored information with the call data identifying the originating device. The method further includes analyzing the call data to determine whether a particular channel has been requested, and if the particular channel has been requested, determining if the originating device is accessible through the particular channel. Additionally, if the originating device is accessible through the particular channel, the method includes sending the associated locally stored information to the originating device through the particular channel.

In still another aspect, a device is provided that includes a communications module for receiving inbound call data, a storage medium including contact information and specific message information that is associated with individual contacts, a processor for executing computer code, and a memory readable by the processor. The memory includes executable instructions configured to cause the processor to analyze incoming call data to determine if an association can be made with respect to the stored contact information and the information describing the originating device; and if so, respond to the call by sending the specific message information of the identified contact.

In yet another aspect, a system is provided for making calls that includes an originating device for making calls, the originating device being configured to transmit call data including an identifier for the originating device. The receiving device is configured to receive the call data in conjunction with an incoming call from the originating device and to analyze the call data to retrieve the identifier for the originating device. The receiving device is further configured to verify the identifier with locally stored information, to generate a response using locally stored information that is associated with the identifier, and to send the response using a protocol that is a point-to-point protocol or a cellular telephone network protocol.

### BRIEF DESCRIPTION OF THE DRAWINGS

FIG. 1 is a functional block diagram generally illustrating a sample mobile device in which implementations of the invention are particularly applicable.

FIG. 2 is a functional block diagram illustrating in greater detail the storage medium loaded with data that is employed by certain implementations of the invention.

FIG. 3 is a conceptual illustration of a system that implements the invention to enable a call receiving device to respond to a call received from the originating device.

FIG. 4 is a functional block diagram generally illustrating a sample message format that may be used in implementations of the invention.

FIG. 5 is an operational flow diagram generally illustrating one implementation of a process performed on a call originating device for providing call identification information to a receiving device.

FIG. 6 is an operational flow diagram generally illustrating a process 600 for handling an incoming call using information provided by the device originating the call.

FIG. 7 is an operational flow diagram illustrating in greater detail a process for handling an incoming call using information provided by the device originating the call.

### DETAILED DESCRIPTION

What follows is a detailed description of various techniques and mechanisms for incoming call-handling. Very generally stated, a telecommunications device and/or service are provided that enable a user to identify a particular incoming caller, select a response that is appropriate for the caller, and send the response to the caller. The originating call can be asynchronous with respect to media communications. The originating call contains information for associating (e.g., identify and/or classify) the caller. After the caller is associated, a response is sent to the caller that is associated with the caller.

Before proceeding, it will be helpful to define some terms that will be used while describing embodiments of the invention. Accordingly, throughout this detailed description, the following terms shall have the meanings ascribed to them here:

The term “call” means any communication between two telecommunication devices, and is not limited to telephone calls. Rather, the term “call” will be used in the broadest sense and includes telephone calls, but also includes any other message or communication between two devices, such as SMS messages, instant messages, e-mail, and the like, whether asynchronous or synchronous, or singly or in combination.

The term “originating device” means a telecommunications device that originates an outbound call. The term originating device may also be used interchangeably with “calling party” or “originating party.”

The term “receiving device” means a telecommunications device that receives an inbound call. The term receiving device may also be used interchangeably with “called party” or “receiving party.”

As briefly mentioned above, mobile devices today are capable of performing many tasks in addition to handling telephone calls. Mobile devices include the capability of sending data and receiving data at the device, such as text messaging, email, and web browsing. The mobile devices typically operate within a cellular network. The cellular network can provide a Short Message Service (SMS) and a Multimedia Message Service MMS. The SMS is usually available for mobile devices such as digital mobile phones, PDAs (portable digital assistants), portable computers, and the like. SMS allows relatively short text messages to be sent to a recipient mobile device. With MMS, a mobile device can send and receive text-only messages as well as multimedia messages such as graphics, video and audio clips, and the like.

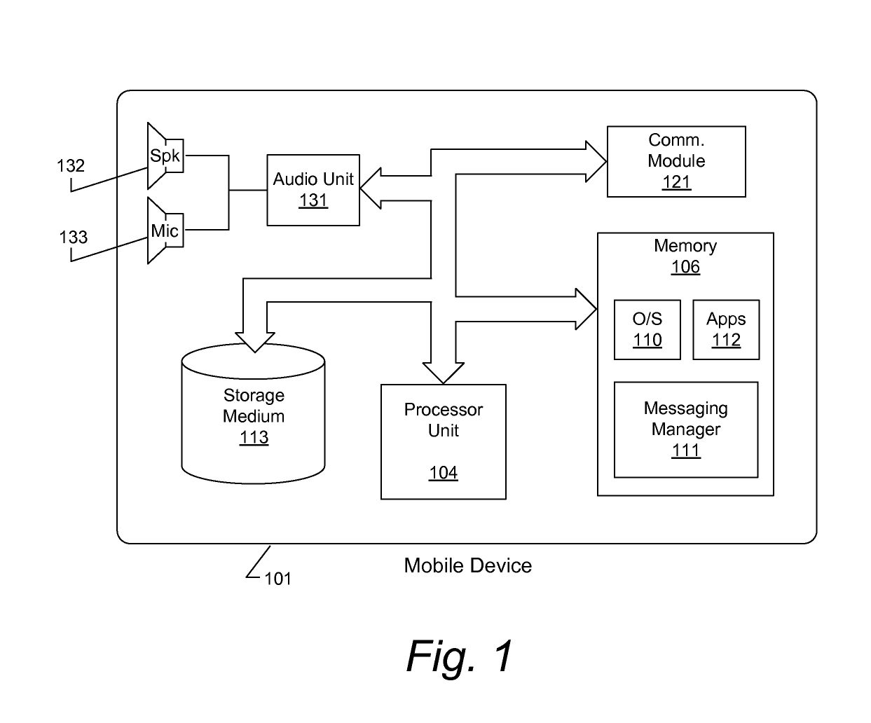

FIG. 1 is a functional block diagram generally illustrating a sample mobile device 101, such as a cellular telephone, in which implementations of the invention are particularly applicable. The mobile device 101 may be any handheld computing device, such as a cellular telephone, a personal digital assistant, a portable music player, a global positioning satellite (GPS) device, or the like, singly or in combination. Although described here in the context of a handheld computing device, it should be appreciated that implementations of the invention may have equal applicability in other areas, such as conventional wired telephone systems and the like.

In this example, the mobile device 101 includes a processor unit 104, a memory 106, a storage medium 113, and an audio unit 131. The processor unit 104 includes a microprocessor or a special-purpose processor such as a digital signal processor (DSP), but could in the alternative be any conventional form of processor, controller, microcontroller, and/or state machine.

The processor unit 104 is coupled to the memory 106, which is implemented as RAM memory holding software instructions that are executed by the processor unit 104. In this embodiment, the software instructions stored in the memory 106 include a message announcement manager 111, an operating system 110, and one or more other applications 112. The memory 106 may be on-board RAM, or the processor unit 104 and the memory 106 could collectively reside in an ASIC. In an alternate embodiment, the memory 106 could be composed of firmware or flash memory.

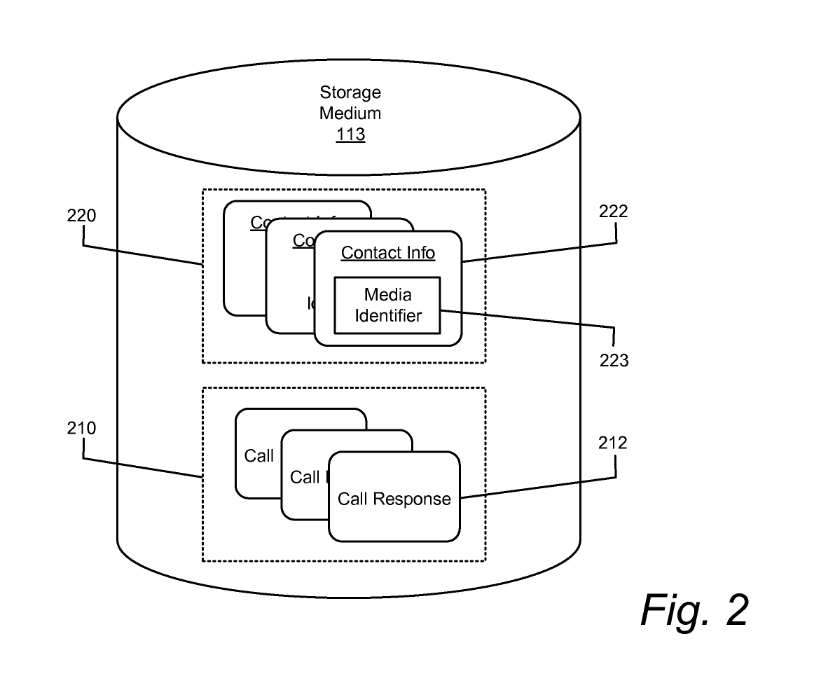

The processor unit 104 is coupled to the storage medium 113, which may be implemented as any nonvolatile memory, such as ROM memory, flash memory, or a magnetic disk drive, just to name a few. The storage medium 113 could also be implemented as any combination of those or other technologies, such as a magnetic disk drive with cache (RAM) memory, or the like. In one embodiment, the storage medium 113 is used to store data during periods when the mobile device 101 is powered off or without power. The storage medium 113 and information that may be stored on it are illustrated in greater detail in FIG. 2 and described below.

The mobile device 101 also includes a communications module 121 that enables bidirectional communication between the mobile device 101 and one or more other computing devices. The communications module 121 may include components to enable RF or other wireless communications, such as a cellular telephone network, Bluetooth connection, wireless local area network, or perhaps a wireless wide area network. Alternatively, the communications module 121 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 131 is a component of the mobile device 101 that is configured to convert signals between analog and digital format (including charge-coupled devices). The audio unit 131 is used to by the mobile device 101 to output sound using a speaker 132 and to receive input signals from a microphone 133. Audible announcements of an incoming call can be created using the audio unit 131 and the speaker 132. For instance, distinctive ringing noises can be played to announce an incoming call. Various musical notes or songs could also be used.

In addition to announcing incoming calls audibly, other mechanisms can also be employed. For example, a vibratory mechanism could be used to announce calls by vibrating the mobile device 101 in a unique manner for different callers. Or, flashing lights and a text message could be sent to inform a targeted caller with a specific message. The breadth of this disclosure is envisioned to encompass announcements delivered using any sensory perceptible mechanism or technique.

The trigger and messaging manager 111 is a utility or service that is configured to identify an appropriate announcement for incoming calls. Briefly stated, the trigger and messaging manager 111 evaluates incoming call data to determine or classify the origin of the incoming call. When the call's origin has been identified, the trigger and messaging manager 111 selects an appropriate response and causes the response to be sent to the caller, where it can be played or otherwise rendered to respond to the call.

FIG. 2 is a functional block diagram illustrating in greater detail the storage medium 113 loaded with data that is employed by certain implementations of the invention. Stored on the storage medium 113 are several call responses 210. In this implementation, the call responses 210 are media files, such as recorded audio (e.g., voice recordings), music, or distinctive audio tones, that are rendered to announce an incoming call. There are several different types of media files in many different formats that could be used to identify incoming calls. For instance, monophonic or polyphonic audio files could be used in different formats, such as MIDI, CMX, RTTTL, AIFF, SMAF, PCM, MP3, and the like. Each call response is typically individually identifiable by some criteria, such as file name or the like.

Although the call responses 210 are described here as audio files, it will be appreciated that the call responses 210 could be any type of resource that includes (and/or generates) description information in any perceptible type of response. For instance, if the mobile device identifies a particular caller, a message can be selected that is appropriate for the caller. For example, one or more call responses 210 could take alternative forms, such as text messages, or the like, that are capable of transmission using a text messaging or e-mail protocol. Similarly, a response can be generated for the incoming call using identified traits of the caller, and then sending the response to the caller. These are but examples and others will become apparent with routine experimentation.

Also on the storage medium 113 reside several “contacts” 220, which are data files or records that describe individuals or entities. Each contact 222 may include information that describes or identifies individuals or entities that may be contacted by the user of the mobile device 101, or that may contact the user. Examples of the information that may be stored in a contact 222 include the name of the person with whom the contact is associated, the company that employs the person, the person's telephone number and address, the person's e-mail address, and other information.

In this implementation, the contact 222 also includes an outbound media identifier 223 that provides identifying (including classifying) information to be used by the receiving device to send responses to incoming calls. In other words, the contact 222 could include an identifier for a particular call response 212 that the user would like to be sent to the caller with whom the contact 221 is associated. The media identifier 223 could be a file name for the particular response to be sent, or some other identifier such as a class of call announcements (e.g., any three-ring stutter tone, any music by Bach, any song of a particular genre, a flashing colored light, SMS, MMS, email, or the like, singly or in combination). Additionally, the media identifier can include information used for, for example, converting a text string to speech, or combining various media resources to provide a response.

In another implementation, responses can be selected based upon time triggers. Contact 222 can optionally contain time trigger information. For example, messages can be selected based upon time windows that that associated with an identified caller such that different messages can be sent the identified caller depending upon when the call was received. To further illustrate, a voice message can be sent during business hours, while an email could be sent after business hours. The time triggers can be set on a recurring or nonrecurring basis, which helps to reduce the attention required by the owner.

The storage medium 113 illustrated in FIG. 2 can reside on both the call originating device and the call receiving device. Although in practice the storage media on both devices could include some of the same information, it will be appreciated that the actual call media files could reside only on the call originating device and be selected by the call receiving device. For example, the response message can include information identifying and playing media files stored on the originating calling device.

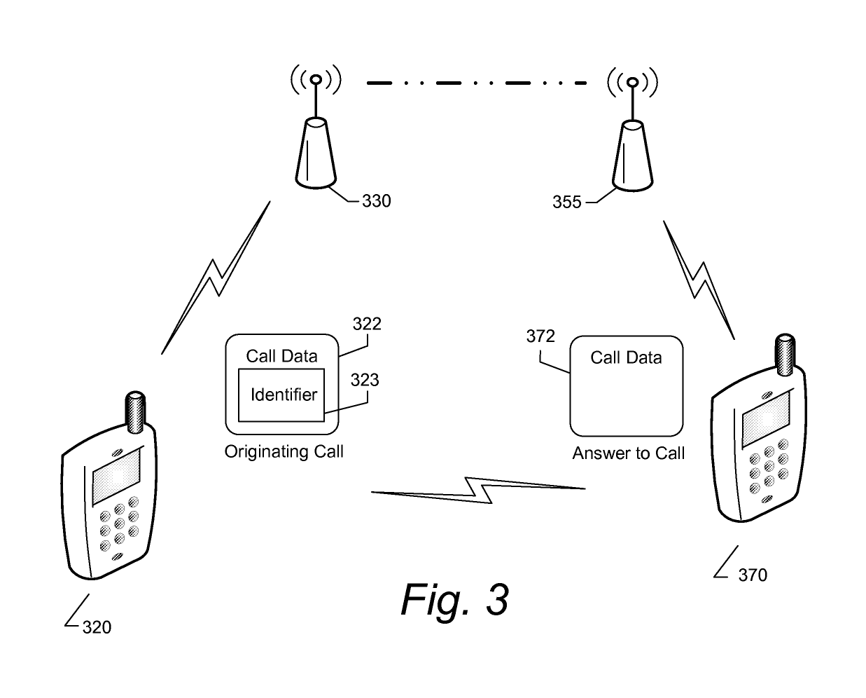

FIG. 3 is a conceptual illustration of a system that implements the invention to enable a call receiving device 370 to respond to a call received from the originating device 320. The response may include data specific to the calling party or the originating device 320.

The originating device 320 initiates the call to the receiving device 370. Call set-up data 322 from the originating device 320 to its Mobile Telephone Switching Office (MTSO 330) includes the called number (an “identifier” 323) that identifies the originating device 320 to the receiving device. The set-up data may optionally include a media identifier (or the like) to specify a preference as to which media (or type of communication) the receiving device should use when responding.

Identifier 323 may comprise information such as an IP address, ESN (electronic serial number), MIN (manufacturers identification number), a voice identifier, a GUID (global user identifier), and the like. Additionally, identifier 323 can merely contain information that is suitable for classifying the call (so that a message can be sent to a class of callers, such as caller ID-blocked numbers, calls from a certain area, and the like).

In one embodiment, the originating device 320 communicates with the MTSO 330 using a next-generation communications technology, such as Voice over IP (VOIP). Moreover, the protocol in use between the originating device 320 and the MTSO 330 to set-up the call can optionally allow the originating device 320 to pass other identifying information to the MTSO 330 in addition to the digits of the called party's number.

Caller ID information may be added to the call data by the MTSO 330 and transmitted to the receiving device's MTSO 355. The identifier 323 may be included in the caller ID information, perhaps as an extension to the Multiple Data Message Format (MDMF) protocol, and transmitted from the MTSO 355 to the receiving device 370.

If an alternative protocol is used to set-up the call, the identifier 323 could be included in whatever data package is transmitted to the receiving device 370. When received, the receiving device 370 extracts the identifier 323 for the originating device and selects (and/or generates) a response that is associated with the originating device. Furthermore, the receiving device 370 can use other information included in the call set-up data 322 to select a channel and/or media type in which to send the selected message. Thus, using this system, the receiving device 320 has selected a response as a call answer 372 that appropriately answers or responds to the incoming call.

The answer 372 may then be transmitted back to the originating device 320. In one example, the receiving device 370 may simply accept the incoming call and render the appropriate answer 372 in a manner similar to a conventional answering machine. Alternatively, the receiving device 370 could construct and transmit a responsive text message (e.g., an SMS message) or e-mail message upon detecting the incoming call from the originating device 320. These and other techniques will become apparent to those skilled in the art.

Differing protocols can be used to originate and/or answer the call. For example, originating device can originate a call using a point-to-point protocol, and the receiving device can place a phone call to the originating device in response. Alternatively, both the originating and receiving device can communicate using a point-to-point protocol, such as SIP or the like.

In some cases, an identifier for the originating device 320 might not exist on the receiving device 370. In that case, the receiving device 370 could do a best-match type analysis, or simply select a generic response. Similarly, the receiving device 370 may not be configured to handle some types of identifiers. In that case, the receiving device 370 could simply ignore the additional information in the call data and announce the call normally.

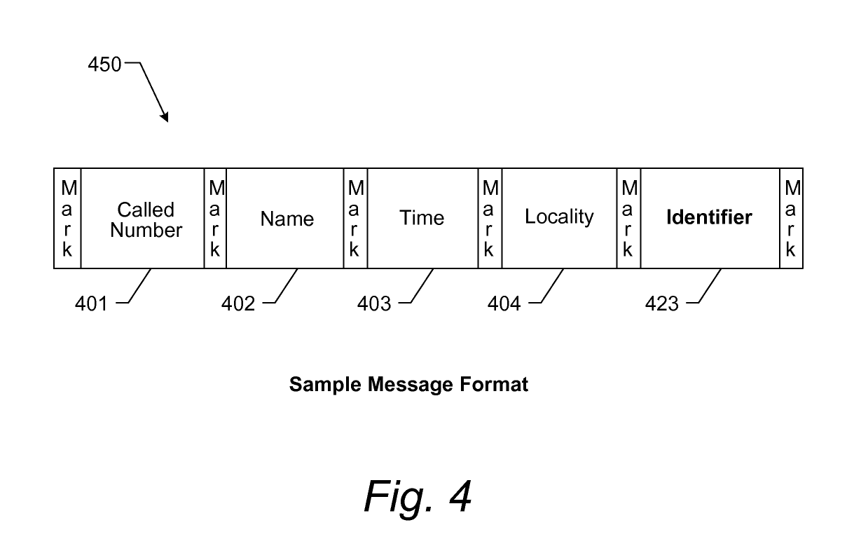

FIG. 4 is a functional block diagram generally illustrating a sample message format 450 that may be used in implementations of the invention. The sample message format 450 is an extension of the existing MDMF protocol used in the telecommunications industry to provide data to the receiving device prior to a call being established. The MDMF protocol allows for the inclusion of certain identifying information about the calling party (e.g., phone number 401, name 402, time 403, locality 404) encoded as a tone provided to the receiving device between the first and second rings, prior to the circuit being connected. The invention envisions an extension to this or a similar protocol to add arbitrary data, namely an identifier 423, provided by the originating device. In this way, the originating device can transmit to the receiving device an identifier for the originating device and any requested media channel.

As mentioned above, the extension can be used to transmit other information as well. For example, either in addition to or in lieu of the identifier 423, the originating device could add compressed voice data that contains information for identifying the call originator. In this way, receiving device can process the data to determine the human caller, as compared to merely being able to identifying the originating call number.

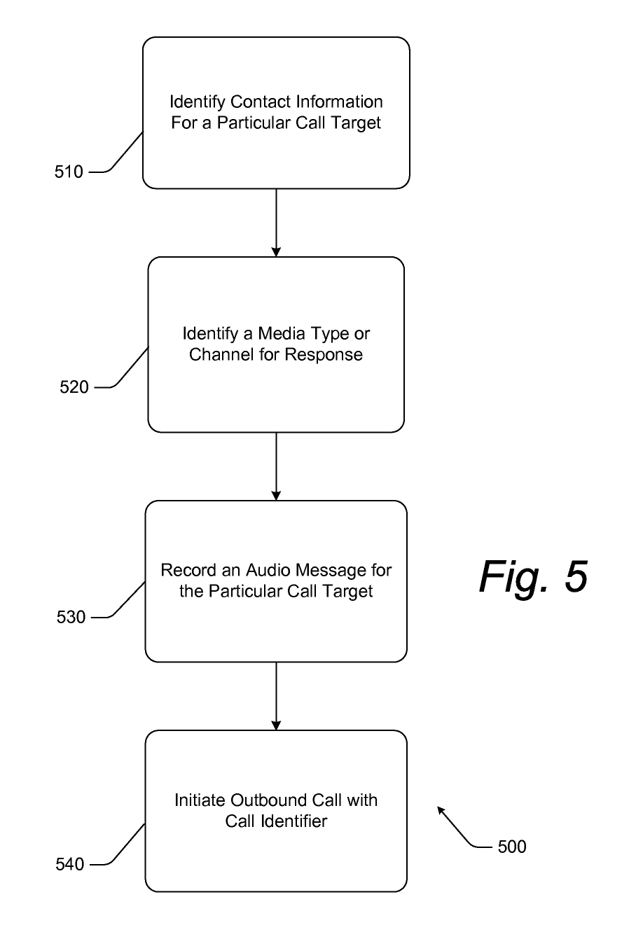

FIG. 5 is an operational flow diagram generally illustrating one implementation of a process performed on a call originating device for providing call identification information to a receiving device. The process 500 may be performed on a telecommunications device configured to make and receive telephone calls or to send and receive other messages, such as electronic mail, SMS and MMS messages, instant messages, and the like.

At step 510, contact information is optionally identified for a particular receiving device. In this implementation, the receiving device represents the entity or individual to which a call can be made, and the contact information includes the mechanism for initiating a call to the receiving device, commonly a telephone number. The contact information may also include additional information about the entity or individual, such as name and address.

At step 520, media type or channel information is optionally specified. In one implementation, a preferred media response type or response channel can be specified. Alternatively, media capabilities of the phone can be specified such that a receiving phone can choose what kind of response to send that is appropriate for the originating device.

At step 530, an audio message from a caller is optionally recorded (or retrieved) to send to a receiving device. For example, a human caller can record a voice message that can allow the receiving device to process the audio such that identification (and/or classification) of the caller can be made.

It should be noted that in the case where a common outbound call is made steps 510 through 530 may be optional or unnecessary. In addition, it should be noted that there is no significance to the order of steps 510 and 520 as any step could be performed first.

At step 540, an outbound call is made that includes information identifying the originating device. In one implementation, the originating device and its switching office communicate using a call set-up protocol that allows arbitrary or other extended data to be transmitted from the originating device to the switching office. For example, in next generation Voice over IP telephony, communications between the originating device and the switching office may be of a form that allows packets of ordinary data, in addition to simply an off-hook signal and calling party number. In this case, the identifying information may simply take the form of a pre-defined message type that is included with call set-up information sent to the switching office from the originating device. It may also include extended information such as full contact information from the originating device or multimedia information. This information could also be obtained either as data transmitted with the call (in the case of a VOIP call) or by a reverse number-to-name lookup in a database of such information.

Alternatively, the originating device can set up a peer-to-peer communication session with the receiving device. The peer-to-peer communication session can be established using, for example, SIP, SMS, MMS, or any other suitable protocol.

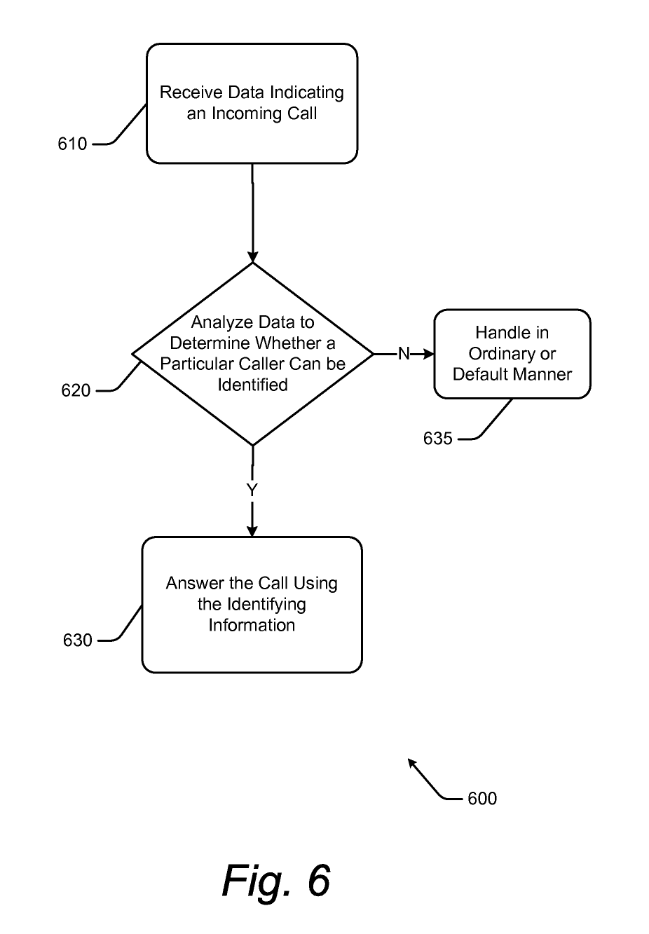

FIG. 6 is an operational flow diagram generally illustrating a process 600 for handling an incoming call using information provided by the device originating the call. The process 600 may be performed on any telecommunications device configured to receive incoming calls and to selectively respond to the originating device.

At step 610, the receiving device receives a notification of an incoming call. In one embodiment, the incoming notification includes caller ID data, such as an MDMF caller ID message, that is encoded with information such as the calling party's (originating device's) telephone number. In addition, the notification may include media type, channel information, and an audio message as described above.

At step 620, the receiving device analyzes the incoming notification to determine whether information is present that can be associated with a caller. In one specific example, the receiving device may decode an MDMF tone to determine a number that is associated with a caller. Alternatively, the incoming notification may take the form of special data messages transmitted using next-generation communication technologies, such as VOIP.

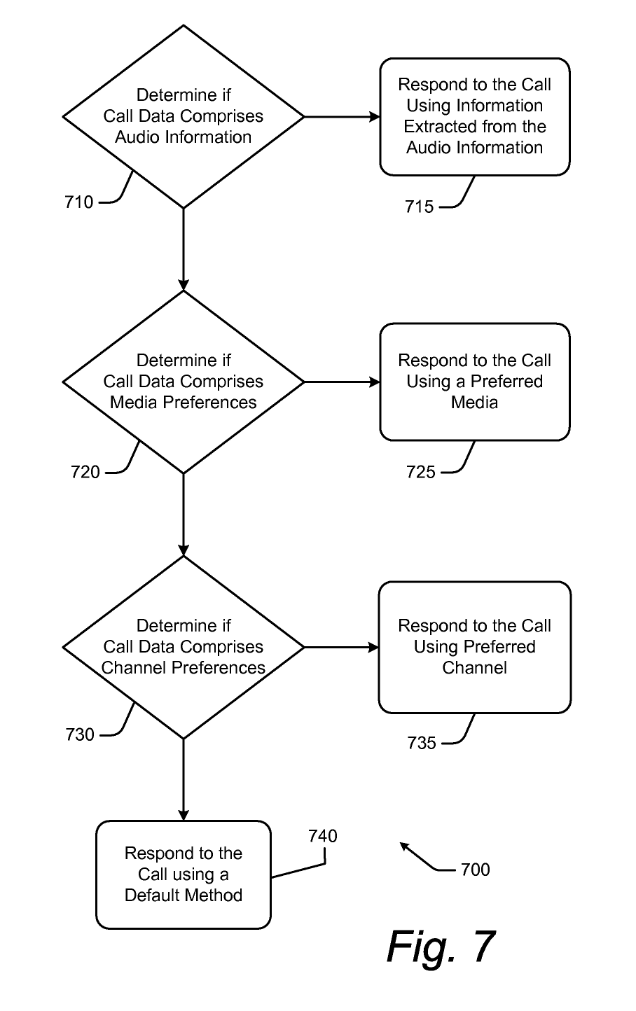

At step 630, if a particular caller has been identified, the receiving device answers the call by using the identifying information to locate information pre-stored on the receiving call device. In one example, the located information can be a voice message that is intended for a particular caller. Alternatively, the response could take the form of a text message, or perhaps even a graphical image. A more detailed description of announcing the incoming call is provided below in conjunction with FIG. 7.

At step 635, if no particular caller has been identified, then the incoming call is handled in an ordinary or default manner.

FIG. 7 is an operational flow diagram illustrating in greater detail a process 700 for handling an incoming call using information provided by the device originating the call. This process 700 is performed when call data is received indicating that a particular caller has been identified for an incoming call.

At step 710, the receiving device determines if the incoming call data comprises audio information, such as when the caller records the caller's name to identify a caller (so that the caller, in addition to the caller phone number) can be identified. If so, then the receiving device renders a response using pre-stored data that is associated with the caller in local memory (step 715).

At step 720, the receiving device determines if the incoming call data comprises a media preference, such as stating a preferred form for a response or stating the media capabilities of the call originating device. If so, then the receiving device renders a response using pre-stored data that is appropriate for the media capabilities of the call originating device (step 725).

At step 730, the receiving device determines if the incoming call data comprises a channel preference, such reply to me via email or send an file using a point-to-point protocol. If so, then the receiving device renders a response and sends the response across a preferred channel (step 735).

At step 740, if no additional identifying information is present, then the incoming call is responded to using a default or other specified call method that is associated with the caller.

Steps 710 through 730 can be performed in any order or combined in any combination. For example, an incoming call may comprise audio information, media preferences, and a preferred channel. The receiving device could then generate a response using a caller identified by the caller's voice, using a preferred media type, and sending the response using a preferred channel.

While the present invention has been described with reference to particular embodiments and implementations, it should be understood that these are illustrative only, and that the scope of the invention is not limited to these embodiments. Many variations, modifications, additions and improvements to the embodiments described above are possible. These variations, modifications, additions and improvements fall within the scope of the invention as detailed within the following claims.

We/I claim:

1. A method for associating call responses in receiving devices, comprising:
storing contact information on an receiving device, the contact information describing an originating device, and the contact information having a particular contact response that is appropriate for the originating device;
receiving an incoming call having identifying information for identifying the originating device;
associating the received identifying information with the contact information stored on the receiving device; and
initiating an outbound call from the originating device to the receiving device, wherein the outbound call comprises the particular contact response.

2. The method recited in claim 1, wherein the particular contact response is a media file that is capable of being received by the originating device.

3. The method recited in claim 2, wherein the media file is a text message.

4. The method recited in claim 1, wherein the identifying information of the incoming call comprises an audio message.

5. The method recited in claim 4, wherein the audio message is a voice recording of the user of the originating device.

6. The method recited in claim 5, further comprising processing the voice recording to identify the user of the originating device.

7. The method recited in claim 1, wherein the outbound call is placed on a channel described in the incoming call.

8. The method recited in claim 7, wherein the described channel is different from the channel of the incoming call.

9. The method recited in claim 8, wherein the described channel operates in accordance with a point-to-point protocol.

10. The method recited in claim 1, wherein the incoming call further describes the media capabilities of the originating device.

11. The method recited in claim 10, wherein the outbound call comprises streaming a media file that is in accordance with the media capabilities of the originating device.

12. The method recited in claim 10, wherein the outbound call comprises an identifier for media stored on the originating device.

13. A method for placing a call to a receiving device from an originating device, comprising:
sending call data associated identifying the originating device to the receiving device;
selecting and sending a response type to the receiving device; and
receiving a response from the receiving device, the response being of the response type.

14. The method recited in claim 13, wherein the call data comprises caller ID data.

15. The method recited in claim 14, wherein the caller ID data comprises data in a multiple data message format.

16. The method recited in claim 13, wherein the response type describes a preferred channel for receiving the response.

17. The method recited in claim 13, wherein the response type describes a preferred media type for receiving the response.

18. The method recited in claim 13, wherein the response type describes the media capabilities of the originating device.

19. The method recited in claim 13, wherein the call data is an audio message.

20. The method recited in claim 19, wherein the audio message is a voice recording of the user of the originating device.

21. A method for responding to an incoming call on a receiving device, comprising:
receiving call data associated with an incoming call, the call data identifying an originating device;
associating locally stored information with the call data identifying the originating device;
analyzing the call data to determine whether a particular channel has been requested;
if the particular channel has been requested, determining if the originating device is accessible through the particular channel; and
if the originating device is accessible through the particular channel, sending the associated locally stored information to the originating device through the particular channel.

22. The method recited in claim 21, further comprising, if the originating device is not accessible through the particular channel, sending the associated locally stored information to the originating device through a channel used to originate the incoming call.

23. The method recited in claim 21, wherein the particular channel uses a point-to-point protocol.

24. The method recited in claim 21, wherein the channel used to originate the incoming call is a cellular phone channel.

25. The method recited in claim 21, wherein the locally stored information is sent in accordance with a time window identified by the identifying call data.

26. The method recited in claim 21, wherein the locally stored information is a text message.

27. The method recited in claim 23, wherein the locally stored information is a media file.

28. A device for receiving calls, comprising:
a communications module for receiving inbound call data containing information describing the originating device;
a storage medium that comprises contact information and specific message information that is associated with individual contacts;
a processor for executing computer code; and
a memory readable by the processor and including executable instructions configured to cause the processor to:
analyze incoming call data to determine if an association can be made with respect to the stored contact information and the information describing the originating device whereby an the contact is identified; and
if so, respond to the call by sending the specific message information of the identified contact.

29. A system for making and receiving calls, comprising:
an originating device for making calls, the originating device being configured to transmit call data including an identifier for the originating device; and
a receiving device for receiving calls, the receiving device being configured to receive the call data in conjunction with an incoming call from the originating device and to analyze the call data to retrieve the identifier for the originating device, the receiving device being further configured to verify the identifier with locally stored information, to generate a response using locally stored information that is associated with the identifier, and to send the response using a protocol that is a point-to-point protocol or a cellular telephone network protocol.

30. A device for responding to an incoming call on a receiving device, comprising:
means for receiving call data associated with an incoming call, the call data comprising a caller ID of an originating device;
means for associating locally stored information with the call data identifying the originating device;
means for analyzing the call data to determine whether a particular channel has been requested;
if the particular channel has been requested, means for determining if the originating device is accessible through the particular channel; and
if the originating device is accessible through the particular channel, means for sending the associated locally stored information to the originating device through the particular channel.

31. A computer-readable medium encoded with computer-executable instructions for associating call responses in receiving devices, comprising:
storing contact information on an receiving device, the contact information describing an originating device, and the contact information having a particular contact response that is appropriate for the originating device;
receiving an incoming call having identifying information for identifying the originating device;
associating the received identifying information with the contact information stored on the receiving device; and
initiating an outbound call from the originating device to the receiving device, wherein the outbound call comprises the particular contact response.

32. A computer-readable medium encoded with computer-executable instructions for responding to an incoming call on a receiving device from an originating device, comprising:
sending call data associated identifying the originating device to the receiving device;
selecting and sending a response type to the receiving device; and
receiving a response from the receiving device, the response being of the response type.
